(19) United States
(12) Patent Application Publication
(10) Pub. No.: US 2022/0276368 A1
(43) Pub. Date: Sep. 1, 2022

(54) ASSET LOCATION TRACKING SYSTEM AND METHOD

(71) Applicant: SmartCone Technologies Inc., Stittsville (CA)

(72) Inventors: Harry Andrei, Manotick (CA); Jacques Y. Guigné, Paradise (CA)

(21) Appl. No.: 17/186,158

(22) Filed: Feb. 26, 2021

(51) Int. Cl. G01S 13/46; H04B 17/318; G06K 19/07

(52) U.S. Cl. CPC G01S 13/46; H04B 17/318; G06K 19/0723; G01S 2013/466

(57) ABSTRACT

A method for locating an object in a facility includes determining position with respect to time of a material handling device associated with a movable vehicle within the facility Signal strength of a signal emitted by at least one identification tag affixed to the object is measured with respect to time. A time that the object is deposited at a fixed position by the material handling device is determined from the measured signal strength. The location in the facility of the fixed position is established using the determined time and the determined position with respect to time.

### CROSS REFERENCE TO RELATED APPLICATIONS

Not Applicable.

### STATEMENT REGARDING FEDERALLY SPONSORED RESEARCH OR DEVELOPMENT

Not Applicable

### Background

This disclosure relates to the field of asset management by location tracking.

More particularly, the disclosure relates to systems and methods for tracking location of physical assets using radio frequency identification (RFID) devices affixed to the assets.

RFID transducers are known in the art for tracking and identification of physical assets. When used for purposes of inventory and product shipping management, it is frequently the case that assets may be misplaced during movement from inventory to a shipping portal for customer delivery. Such misplacement can slow down the time in which workers can effectively turn over assets in a warehouse, distribution or fulfillment center. Another issue is that workers are not able to optimize the flow of assets through the warehouse, distribution or fulfillment center without real time data on the location of the assets. Another issue is that there may be equipment and/or assets in the warehouse, distribution or fulfillment center that incur an additional rental cost based on the duration that they are in the warehouse, distribution or fulfillment center. Without real-time tracking, such equipment or freight could remain in the warehouse far beyond its intended use and cause additional expense.

There is a need for a real time asset location tracking system to aid in addressing the foregoing issues.

### SUMMARY

One aspect of the present disclosure is a method for locating an object in a facility. A method according to this aspect of the disclosure includes determining position with respect to time of a material handling device associated with a movable vehicle within the facility. Signal strength of a signal emitted by at least one identification tag affixed to the object is measured with respect to time. A time that the object is deposited at a fixed position by the material handling device is determined from the measured signal strength. The location in the facility of the fixed position is established using the determined time and the determined position with respect to time.

A computer program according to another aspect of this disclosure is stored in a non-transitory computer readable medium. The computer program comprises logic operable to cause a programmable processor to perform actions comprising determining position with respect to time of a material handling device associated with a movable vehicle within a facility. The logic causes the computer to perform measuring with respect to time signal strength of a signal emitted by at least one identification tag affixed to an object; determining from the measured signal strength a time that the object is deposited at a fixed position by the material handling device; and establishing the location in the facility of the fixed position using the determined time and the determined position with respect to time.

In some embodiments, the position with respect to time is determined by determining with respect to time a position of the movable vehicle and at least one of a geodetic or geomagnetic direction of the vehicle.

Some embodiments further comprise determining from the measured signal strength a time at which the object is retrieved by the material handling device from the measured signal strength.

Some embodiments further comprise filtering the measured signal strength to determine the retrieval time and the deposit time.

In some embodiments, the filtering comprises determining a mean value of signal strength and a standard deviation of at least one of a plurality of highest magnitudes of the measured signal strength and a plurality of most frequently occurring values of the measured signal strength.

In some embodiments, the measuring signal strength is started when the signal strength exceeds a selected threshold and is stopped when the signal strength falls below the selected threshold for a predetermined duration of time.

A method for locating an object in a facility according to another aspect of the present disclosure includes determining position with respect to time of a movable vehicle within the facility.

Signal strength is measured with respect to time of a signal emitted by at least one identification tag affixed to the object at least three different positions of the movable vehicle. A location in the facility of the identification tag is established using the signal strength at the at least three different positions.

In some embodiments, the establishing location comprises least squares trilateration.

Other aspects and possible advantages will be apparent from the description and claims that follow.

### BRIEF DESCRIPTION OF THE DRAWINGS

FIG. 1 shows a schematic diagram of components of an example embodiment of an asset tracking system according to the present disclosure.

FIG. 2 shows a densely-populated graph of received signal strength (RSSI) with respect to time used in asset pick up and drop off location determination.

FIG. 3 shows a sparsely-populated graph of received signal strength (RSSI) with respect to time used in asset pick up and drop off location determination.

FIG. 4 shows a flow chart of a procedure to determine a first candidate time for a drop off point of an object having an RFID tag from RS SI data.

FIG. 5 shows a flow chart of a procedure to determine a second candidate drop off time from the RSSI data.

FIG. 6 shows a flow chart of a procedure to determine a pick up time from the RSSI data.

FIG. 7 shows a schematic diagram of using vehicle mounted location beacons for asset position determination.

### DETAILED DESCRIPTION

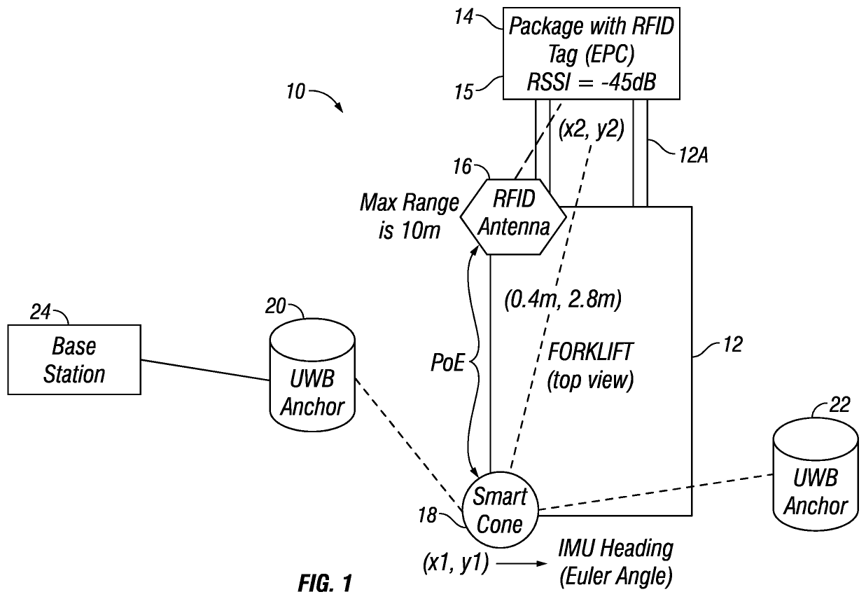

FIG. 1 shows a schematic diagram of an example embodiment of an asset tracking system according to the present disclosure. The asset tracking system 10 may comprise an object handling or material handling vehicle 12 such as a forklift or other device used to handle, move, remove from storage areas and replace in storage areas certain assets within a facility such as a warehouse or product fulfillment center. While the vehicle 12 is shown as a forklift, any other material handling vehicle that has a material or object handling device 12A may be used in accordance with a system according to the present disclosure. For purposes of the present disclosure, the asset being located and moved will be referred to herein as an “object.”

An object or asset whose position is to be tracked is shown at 14 in FIG. 1, and the object 14 may be, for example, a pallet having physical goods loaded thereon, or physical goods themselves, depending on the size and how in the particular facility such objects are stored and transported. The object 14 may comprise a radio frequency identification (RFID) tag 15 or other transponder affixed to it, wherein the RFID tag 15 transmits identification information concerning the object 14. The RFID tag 15 may be, for example, a passive, externally excited radio frequency device of any type known in the art for object tracking. An antenna for detecting signals from the RFID tag 15 is shown at 16. The antenna 16 may be disposed on the vehicle 12 in any suitable location, and may be in signal communication with a vehicle and asset location system 18 disposed in a suitable location on the vehicle 18. The vehicle and asset location system 18 may be one sold under the trademark SMARTCONE, which is a trademark of SmartCone Technologies, Inc., Stittsville, Ontario, Canada., and may comprise, for example, radio frequency and/or acoustic signal generators, wherein the signals are detectable by one or more fixed location transducers 20, 22 disposed in the facility for which movable assets are to be tracked. Signal detection on the vehicle and asset location system 18 of signals emitted by devices in the transducers 20, 220 may be of equal effect as signal generation on the vehicle 12 and detection at the transducers 20, 22; therefore, the location of signal generators and related signal receivers in the vehicle and asset location system and the transducers 20, 22 are not limitations of any particular embodiment. It is only necessary to be able to determine the position of the vehicle 12 within the facility at any time.

The foregoing system components may provide, at any time, that the location of the vehicle 12 in the facility may be determined and recorded. The vehicle and asset location system 18 may be in signal communication with the antenna 16, such that signals from one or more RFID tags, e.g., 15 in FIG. 1, may be detected, and asset identification (ID) and related signal strength (RSSI) information from the respective RFID tag 15 may be detected and recorded. Signals from the fixed location transducers 20, 22 may be communicated to a base station 24, wherein time-dependent position of the vehicle 12, identification information and RSSI from one or more RFID tags 15 may be recorded.

The vehicle and asset location system 18 may further comprise any sensor or device enabling determination of the vehicle's orientation, e.g., its geodetic and/or geomagnetic direction (heading). It will be appreciated that for purposes of convenience the vehicle and asset location system 18 may be located on the vehicle 12 so that it is displaced from the part of the vehicle 12 that comes into contact with and moves the object 14, namely, the object handling device 12A. Thus, the determined vehicle position within the facility may not directly correspond to the position of the object handling device 12A, and when the object handling device 12A contacts the object 14, thereby the position of the object 14. In some embodiments, therefore, the vehicle and asset location system 18 may comprise any one or more sensors that make measurements corresponding to geodetic or geomagnetic heading, for example and without limitation, gyroscopes and magnetometers that can measure orientation with respect to geodetic or geomagnetic pole direction. Thus, determinations of the vehicle position and the vehicle heading (and the known, fixed relationship between the object handing device 12A and the vehicle and asset location system 18) may be combined to determine at any time the position of the object handling device 12A. It will also be appreciated that the vehicle's heading may instead, or in addition, be determined with reference to the facility itself. That is, the rotational orientation of the vehicle 12 may be determined with respect to any chosen reference point in the facility. Using a local reference point to determine vehicle orientation may require additional sensors and signal processing than would be needed if geomagnetic or geodetic reference is used for the vehicle heading, however.

As will be further explained, analysis of RFID signals, more specifically, signal strength, from the object's RFID tag 15 may be used to determine when the object 14 is disposed on the object handling device 12A, such that position of the object handling device 12A corresponds to the position of the object 14. Once the vehicle 12 moves the object 14 to a fixed location, e.g., on a shelf or other predetermined fixed position within the facility, such fixed location may be stored by the base station 24 (or any other data storage and processing device) until which time the object 14 is retrieved by the vehicle 12 or by another vehicle (not shown). Upon such retrieval and any subsequent movement, the position of the object 14 may be determined and recorded with respect to time as it is moved within the facility.

It will be appreciated that the vehicle 12 position could be determined using a geodetic signal position receiver, such as a GPS or GNSS satellite signal receiver, and the present disclosure should not be construed as excluding such embodiments. For enclosed facilities in which satellite signal reception may be compromised, some embodiments according to the present disclosure may advantageously use position determination systems that have their own location signal generators, for example the SMARTCONE system described above. However, the specific device used to determine vehicle position and heading are not limitations on the scope of this disclosure.

The asset location system 10 explained above may therefore record with respect to time the position and heading of the vehicle 12, and from any one or more RFID tags 15 record with respect to time the identification information from the RFID tag 15 and the received signal strength (RSSI) of each such RFID tag within RFID signal communication range at any time. The identification information will not change for any specific RFID tag with respect to time, however the RSSI will change depending on the distance between the respective RFID tag and the antenna 16. Such data may be recorded in the base station 24 or any other suitable data storage and processing unit associated with the asset location tracking system 10. RSSI information may be used to determine when the object 14 is picked up by the vehicle 12 and when the object 14 is dropped off by the vehicle 12 as will be further explained below.

The base station 24 or any other data processing device (not shown in FIG. 1) may comprise a processor (not shown) for performing certain analysis on the above-described data to enable determining at any time the location in the facility of any one or more assets, e.g., object 14 in FIG. 1, as such object(s) are moved within the facility and placed at any location within the facility for later retrieval.

Signal processing according to the present disclosure makes use of the observation that when the object 14 is picked up by the vehicle 12, there will be an identifiable ramp-up in RSSI with respect to time, then a relatively steady state RSSI while the object 14 is moved and remains in a fixed position with reference to the antenna 16. Steady state RSSI is then followed by a ramp-down of the RSSI when the object 14 is dropped off by the vehicle 12 at a chosen location and the vehicle 12 subsequently moves away from the object 14. By analyzing the RSSI with respect to time, it is possible to ascertain when the object 14 was picked up, moved by the vehicle and dropped off. When the time dependent RSSI is associated with the determined vehicle position (e.g., with reference to the facility) and the object handling device position (determined from the vehicle heading as explained above) it is then possible to determine object position in the facility at the time of object pick up, during its transport, and at the time of object drop off. Object position at the time of drop off may be recorded and used for subsequent retrieval of the object 14.

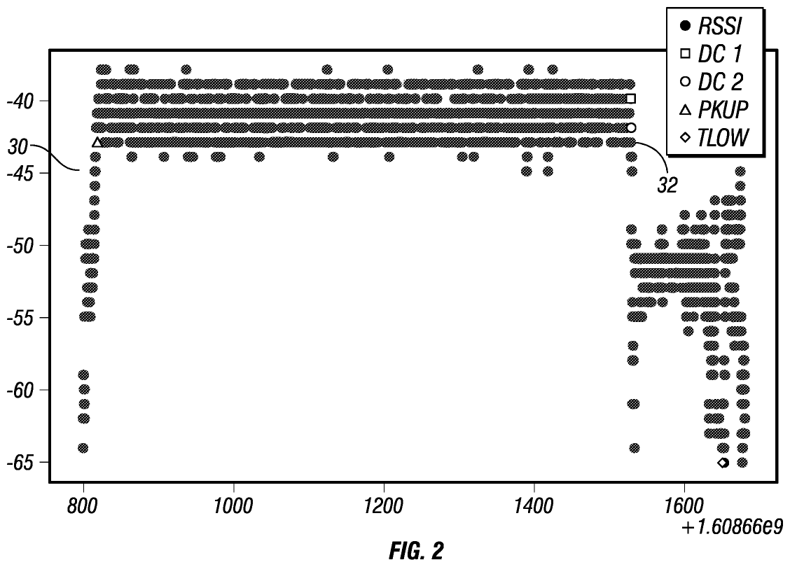

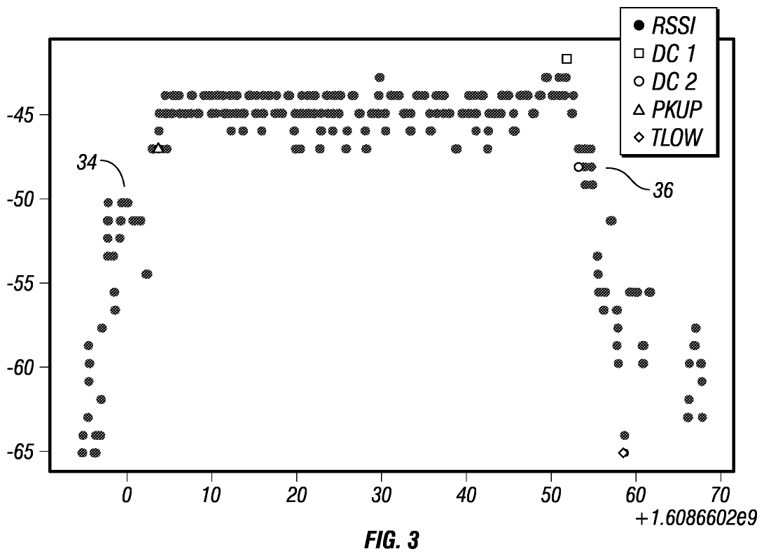

Referring to FIG. 2, which is a “densely populated” graph of RSSI with respect to time, and to FIG. 3, which is a “sparsely populated graph of RSSI with respect to time, as can be observed, abrupt changes in the RSSI with respect to time, see, e.g., 30 and 32 in FIGS. 2 and 34, 36 in FIG. 3, indicate where a pick up or drop off of the object (14 in FIG. 1) is likely to have occurred.

To improve the reliability of selecting the pick up and drop off times from the RSSI measurements, it is useful to filter the RSSI measurements. Filtering may reduce false determination of pick up and drop off times in view of the likelihood that the RSSI values are noisy. In the present example embodiment, filtering the RSSI data may be performed using one or more statistical approaches.

In an example embodiment of data processing according to the present disclosure, there are three parts to the analysis of RSSI to determine pick up and drop off. The first part is to extract statistical information from the RSSI/time data. Then an iterative process is performed using the RSSI/time data and the statistical information to determine candidate drop off positions DC1, DC2. Further analysis may be used to resolve which of the candidate drop off positions, DC1 or DC2 is more likely to be the actual drop off point. Further analysis may be used to determine the pickup point.

As the vehicle (12 in FIG. 1) moves through the facility, signals may be received from one or more RFID tags, e.g., 15 in FIG. 1. For each such tag detected, data recording may begin when the RSSI exceeds a selected threshold. Recording for such tag may continue until the RSSI drops below the same or different threshold. Stopping recording may be delayed until the RSSI is below the selected threshold for a predetermined time interval to avoid premature ending of recording, in the case of momentary drops in RSSI caused other than by the vehicle moving away from the RFID tag. For any tag associated with an RFID-tagged object that is picked up by the vehicle, the RSSI will have characteristics similar to what is shown in the graphs in FIGS. 2 and 3. RSSI/time values may be processed in sets corresponding to the graphs in FIGS. 2 and 3, whose time limits have been determined as explained above.

In a set of RSSI values, a chosen number, e.g., five, of the highest RSSI magnitudes may be selected from all RSSI values in the set. A first standard deviation (or variance) of the highest RSSI values may be calculated. In the same set, the values of RSSI having the highest number, e.g., five, of occurrences may be chosen. A second standard deviation (or variance) of the RSSI values having the foregoing highest number of occurrences may then be calculated. The smaller of the first and the second standard deviations (or variances) may be chosen for subsequent processing. A mean, e.g., arithmetic mean value of all RSSI values in the set may also be determined.

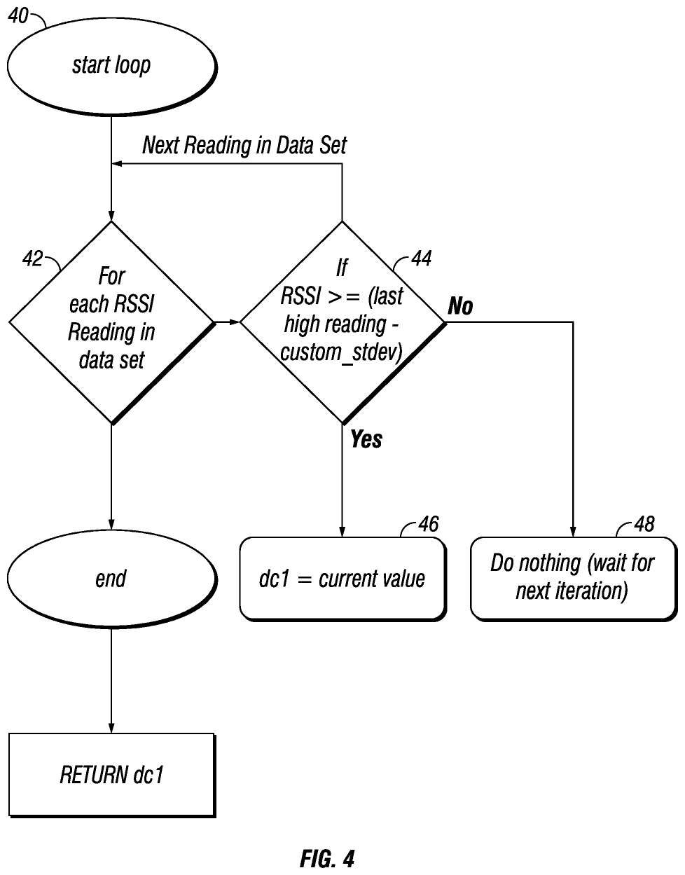

Referring to the flow chart in FIG. 4, the first drop off candidate DC1 may be chosen from the RSSI values in a processing loop 40, that begins in the set by, at 42, interrogating the RSSI values in the set sequentially, beginning with the earliest (in time) RSSI value in the set. If, at 44, a subsequent value of RSSI less the above determined standard deviation is greater than the present value of RSSI less the standard deviation, then the subsequent RSSI value and its associated time are set, at 46, as the candidate drop off point DC1. If the subsequent RSSI value less the standard deviation, at 46, is not greater than the present value, the existing candidate DC1 remains unchanged. The foregoing process is repeated until all RSSI values in the set have been interrogated. The final remaining value of DC1 is thus determined.

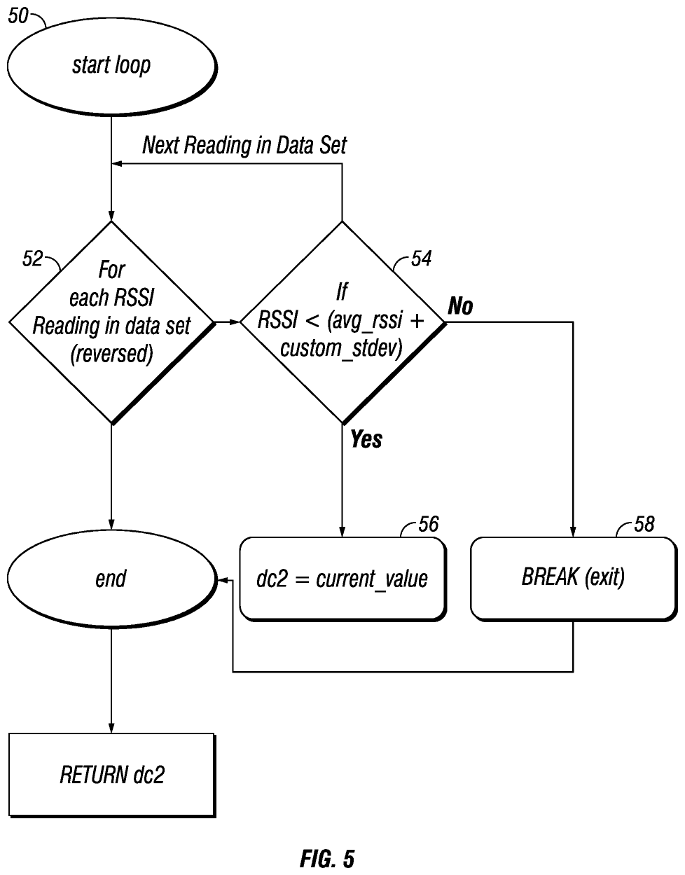

Referring to the flow chart in FIG. 5, the second drop off candidate DC2 may be chosen from the RSSI values in a processing look 50 that begins in the set, at 52, by interrogating the RSSI values in the set sequentially, beginning with the latest (in time) value of RSSI in the set. At 54, if the current RSSI value is less than the sum of the above determined mean and the determined standard deviation, the current RSSI value and its associated time are set as the candidate drop off DC2 at 56, and the process returns to the next RSSI value in the set. If the foregoing condition is not met, at 58, then the previous value of RSSI and associated time remain as the value for DC2.

Because the vehicle and asset location system (18 in FIG. 1) only determines the position of the machinery that is carrying the RFID antenna (16 in FIG. 1), that is, the vehicle, the location of the object handling device (12A in FIG. 1) may be adjusted to reflect the center of the object being moved in reference to the antenna and RFID tag (15 in FIG. 1). The process may use any known vector rotation algorithm to translate the coordinates of the vehicle and asset location system (18 in FIG. 1) on the vehicle (12 in FIG. 1) to the position of the object handling device (12A in FIG. 1) e.g., the geometric center of forks if the object handling device is a forklift.

Then whether DC 1 or DC 2 is the better candidate for the location of the vehicle at the time of pick up or drop off is determined. In the present example embodiment, the choice may be made by the following process. If DC1 is later in time than DC2 and the RSSI value at DC2 is greater than the RSSI value at DC1, then DC2 may be selected as the drop off point. The material handing device position at the time of DC2 may then be stored as the object location within the facility. If, however, the RSSI value of DC1 is equal or greater than the RSSI value at DC2, then DC1 becomes the drop off point.

If DC2 is later in time than DC1, then the RSSI value at DC1 is compared to the previously determined mean value of RSSI plus a factor, comprising the determined standard deviation plus two. The factor may be adjusted to improve reliability of selecting DC1 or DC2. If DC1 is greater than the foregoing amount, then DC2 is chosen as the drop off point. If the foregoing condition is not met, then DC1 may be selected as the drop off point.

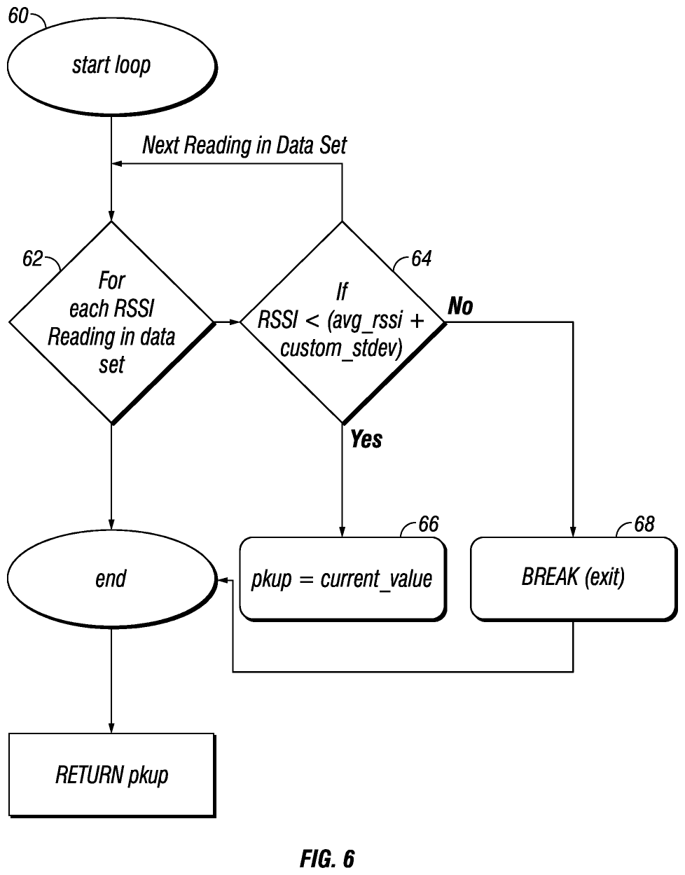

The pick up point may be determined, and referring to the flow chart in FIG. 6, by a processing loop at 60 that includes corresponding steps at 62, 64, 66 and 68 to the steps for determining DC2 explained with reference to FIG. 5, but interrogating the RSSI values in the set in forward time order rather than from the latest in time value in reverse time order that may be used to determine DC2.

In another aspect of the present disclosure, the base station (24 in FIG. 1) or any other computer, microcomputer, processor or group of the foregoing devices or combinations thereof, wherever located, may use positions of the vehicle (12 in FIG. 1), vehicle heading and measurements of RSSI detected by the antenna (16 in FIG. 1) to determine object location as explained above. A software product stored in any non-transitory computer readable medium may be used to program the processor(s) or any similar device(s) to perform actions to locate the object within the facility as explained with reference to FIGS. 2 through 6.

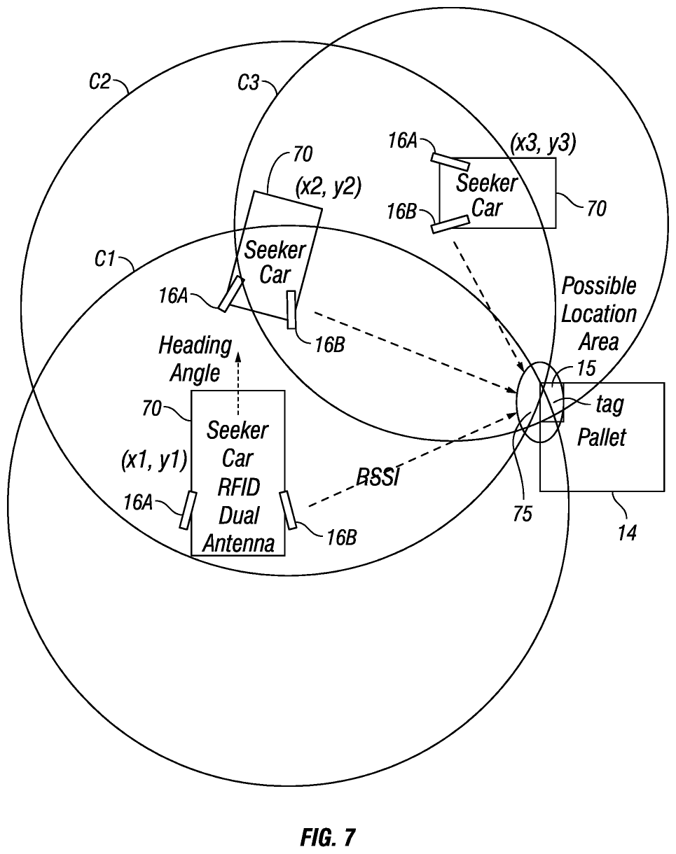

Referring to FIG. 7, in another aspect of the present disclosure, assets (objects 14) that may avoid tracking or may not have been tracked by the system described with reference to FIG. 1 may be located within the facility for subsequent location tracking by the asset tracking system (10 in FIG. 1). One or more “seeker” vehicles 70, which may be material handling vehicles as explained with reference to FIG. 1 or which may be other vehicles having only an asset and vehicle location system (as explained with reference to numeral 18 in FIG. 1) and RFID antenna(s) 16A, 16B, may traverse the facility. A record may be made of the seeker vehicle(s) 70 position within the facility with respect to time. Coincidentally, a record is made with respect to time of the RSSI from each detected RFID tag 15 on each tagged object or asset 14. As explained with reference to FIGS. 2 and 3, in general the RSSI will be related to the distance between the antenna(s) 16A, 16B and the RFID tag 15. Such distance may determine a circle of possible locations of the object with reference to the vehicle 70 location at any time, shown for three vehicle positions at C1, C2 and C3 in FIG. 7. When three or more different vehicle locations and corresponding different distances (based on RSSI) are determined, a likely location of the object may be determined as the intersection of the circles C1, C2, C3. Such location may be stored in the base station (24 in FIG. 1) or other data storage and processing device.

However, determining likely location of the RFID tag 15 may be complicated by, at the least, variation in RSSI from the RFID tag 15. Thus, using RSSI as a proxy for distance between the vehicle and the RFID tag 15 may require additional processing. There are known algorithms on how to account for imprecise measurements when attempting trilateration. Instead of attempting to find the exact intersection of circles, a minimization algorithm may be used to find an area with the lowest error, and so most likely to be the location within an area 75 rather than the precise intersection point. This is known as non-linear least squares trilateration and an example of a specific algorithm used may be the Levenberg—Marquardt minimization algorithm.

In light of the principles and example embodiments described and illustrated herein, it will be recognized that the example embodiments can be modified in arrangement and detail without departing from such principles. The foregoing discussion has focused on specific embodiments, but other configurations are also contemplated. In particular, even though expressions such as in “an embodiment,” or the like are used herein, these phrases are meant to generally reference embodiment possibilities, and are not intended to limit the disclosure to particular embodiment configurations. As used herein, these terms may reference the same or different embodiments that are combinable into other embodiments. As a rule, any embodiment referenced herein is freely combinable with any one or more of the other embodiments referenced herein, and any number of features of different embodiments are combinable with one another, unless indicated otherwise. Although only a few examples have been described in detail above, those skilled in the art will readily appreciate that many modifications are possible within the scope of the described examples. Accordingly, all such modifications are intended to be included within the scope of this disclosure as defined in the following claims.

What is claimed is:

1. A method for locating an object in a facility, comprising:
determining position with respect to time of a material handling device associated with a movable vehicle within the facility;
measuring with respect to time signal strength of a signal emitted by at least one identification tag affixed to the object;
determining from the measured signal strength a time that the object is deposited at a fixed position by the material handling device; and
establishing the location in the facility of the fixed position using the determined time and the determined position with respect to time.

2. The method of claim 1 wherein the position with respect to time is determined by determining with respect to time a position of the movable vehicle and at least one of a geodetic or geomagnetic direction of the vehicle.

3. The method of claim 1 further comprising determining from the measured signal strength a time at which the object is retrieved by the material handling device from the measured signal strength.

4. The method of claim 3 further comprising filtering the measured signal strength to determine the retrieval time and the deposit time.

5. The method of claim 4 wherein the filtering comprises determining a mean value of signal strength and a standard deviation of at least one of a plurality of highest magnitudes of the measured signal strength and a plurality of most frequently occurring values of the measured signal strength.

6. The method of claim 1 wherein the measuring signal strength is started when the signal strength exceeds a selected threshold and is stopped when the signal strength falls below the selected threshold for a predetermined duration of time.

7. The method of claim 1 further comprising filtering the measured signal strength to determine the retrieval time and the deposit time.

8. The method of claim 7 wherein the filtering comprises determining a mean value of signal strength and a standard deviation of at least one of a plurality of highest magnitudes of the measured signal strength and a plurality of most frequently occurring values of the measured signal strength.

9. A computer program stored in a non-transitory computer readable medium, the computer program comprising logic operable to cause a programmable processor to perform actions comprising:
determining position with respect to time of a material handling device associated with a movable vehicle within a facility;
measuring with respect to time signal strength of a signal emitted by at least one identification tag affixed to an object;
determining from the measured signal strength a time that the object is deposited at a fixed position by the material handling device; and
establishing the location in the facility of the fixed position using the determined time and the determined position with respect to time.

10. The computer program of claim 9 wherein the position with respect to time is determined by determining with respect to time a position of the movable vehicle and at least one of a geodetic or geomagnetic direction of the vehicle.

11. The computer program of claim 9 further comprising logic operable to cause the computer to perform determining from the measured signal strength a time at which the object is retrieved by the material handling device from the measured signal strength.

12. The computer program of claim 11 further comprising logic operable to cause the computer to perform filtering the measured signal strength to determine the retrieval time and the deposit time.

13. The computer program of claim 12 wherein the filtering comprises determining a mean value of signal strength and a standard deviation of at least one of a plurality of highest magnitudes of the measured signal strength and a plurality of most frequently occurring values of the measured signal strength.

14. The computer program of claim 9 wherein the measuring signal strength is started when the signal strength exceeds a selected threshold and is stopped when the signal strength falls below the selected threshold for a predetermined duration of time.

15. The computer program of claim 9 further comprising logic operable to cause the programmable computer to perform filtering the measured signal strength to determine the retrieval time and the deposit time.

16. The computer program of claim 15 wherein the filtering comprises determining a mean value of signal strength and a standard deviation of at least one of a plurality of highest magnitudes of the measured signal strength and a plurality of most frequently occurring values of the measured signal strength.

17. A method for locating an object in a facility, comprising:
determining position with respect to time of a movable vehicle within the facility;
measuring with respect to time signal strength of a signal emitted by at least one identification tag affixed to the object at least three different positions of the movable vehicle;
establishing a location in the facility of the identification tag using the signal strength at the at least three different positions.

18. The method of claim 17 wherein the establishing location comprises least squares trilateration.
